(19) United States
(12) Patent Application Publication
(10) Pub. No.: US 2002/0067886 A1
(43) Pub. Date: Jun. 6, 2002

(54) Optical fiber output beam-shaping device for a wavelength division multiplexer (WDM) assembly

(76) Inventor: Michael P. Schaub, Tucson, AZ (US)

Correspondence Address: Benman & Collins, 75 W. Calle de las Tiendas, Suite 125B, Green Valley, AZ, 85614, US

(21) Appl. No.: 09/727,999

(22) Filed: Dec. 1, 2000

(51) Int. Cl. G02B 6/32; G02B 6/26; G02B 6/293; H04J 14/02

(52) U.S. Cl. 385/33; 385/31; 385/24; 359/131

(57) ABSTRACT

An optical fiber output beam-shaping device for a wavelength division multiplexer (WDM) assembly is provided. The beam-shaping device comprises a plano surface, on which one end of a fiber optic is terminated, a reflecting surface, such as a mirror or total internal reflection (TIR) surface, and a beam-shaping lens. The beam-shaping device itself may be of one-piece construction, or the beam-shaping device and a lens array for the WDM may be fabricated as a unitary body. A method for forming such one-piece bodies (beam-shaping device or combination of beam-shaping device and lens array) is disclosed. Because the combination of the optical fiber output beam-shaping device and lens array is of unitary, or one-piece, construction, alignment issues involving introducing optical output from an optical fiber into (1) a beam-shaping lens and then (2) a WDM device are reduced. A cavity in the beam-shaping device secures the optical fiber, the output end of which terminates at the plano surface, which is perpendicular to the end of the optical fiber. The optical signal is then sent to the beam-shaping lens (the mirror or TIR surface introduces the optical signal into the beam-shaping lens). Following shaping, the optical signal is split into its component wavelengths (at least two) by the WDM. Of course, the combination can be operated in reverse, and the optical signals combined in the WDM and the resulting shaped beam converged onto the end of the optical fiber for transmission.

### TECHNICAL FIELD

The present invention relates generally to wavelength division multiplexers (and demultiplexers), commonly abbreviated as “WDM”, and, more particularly, to an optical fiber output beam-shaping device for introducing optical radiation from an optical fiber into a WDM.

### BACKGROUND ART

Wavelength division multiplexing (WDM) is a scheme being used in the fiber optic industry to increase data transmission. WDM consists of using multiple wavelengths, or colors, over a single fiber to send several signals at the same time. There are several methods known in the art for launching the multiple signals into the fiber and for retrieving them, involving combining the various signals in the former case and separating the various signals in the latter case.

Optical radiation, or light, travels along the optical fiber and at the termination of the optical fiber, is launched into the WDM by means of a collimating lens. Alternatively, multiple optical signals may be separated by the WDM and sent to a series of detectors or launched into a plurality of optical fibers. Alternatively, signals from multiple sources (e.g., VCSELs—Vertical Cavity Surface Emitting Lasers—or optical fibers) can be combined and sent down a single optical fiber. In any event, alignment of the optical fiber, the collimating lens, and the WDM are critical, and a number of approaches have been taken to solve them.

An example of alignment of an optical fiber and a collimating lens is disclosed in U.S. Pat. No. 4,718,744, entitled “Collimating Lens and Holder for an Optical Fiber”, issued on Jan. 12, 1988, to Randy M. Manning and assigned to AMP Inc. In that patent, a spherical collimating lens and a holder for the optical fiber are formed on the inner surface of a cavity of an optically transmissive body. The cavity is said to be suitable for formation by a single core pin. The surface of the core pin may be machined accurately to form both the lens and the holder, during fabrication of the body by molding “fluent” plastics material in a molding apparatus. In the molding apparatus, the core pin forms the lens and the holder on a continuous surface of the cavity in the body. The axial alignment of the lens and holder are said not to vary during repeated use of the core pin in the molding apparatus. However, while the alignment of an optical fiber and a collimating lens is shown, no information is given regarding integrating such a device with WDMs nor with dealing with alignment issues in such integration.

Thus, a need remains for a one-piece assembly for a optical fiber output beam-shaping device for combining with a WDM and for its facile manufacture that reduce alignment concerns.

### DISCLOSURE OF INVENTION

In accordance with the present invention, an optical fiber output beam-shaping device for a wavelength division multiplexer assembly is provided. The beam-shaping device comprises (1) a piano surface, or fiber stop, at which one end of an optical fiber is terminated, (2) a reflecting surface, and (3) a beam-shaping lens.

In particular, the optical fiber output beam-shaping device serves to couple an optical signal between an optical fiber and a wavelength division multiplexer or wavelength division demultiplexer, wherein the optical signal comprises at least two different wavelengths. The device comprises:

(a) a body of optically transmissive plastic;

(b) a cavity within the body having an entrance for receiving an end portion of the optical fiber and terminating at a fiber stop, against which an end of the optical fiber is terminated;

(c) a reflecting surface formed in the body opposite the end of the optical fiber, which provides reflection of the optical signal emanating from the end of the optical fiber, and

(d) a beam-shaping lens formed in the body for shaping the optical signal reflected from the reflecting surface,

whereby the device is of one-piece construction.

Further in accordance with the present invention, a combination of the optical fiber output beam-shaping device and WDM is provided. The wavelength division multiplexer (or wavelength division demultiplexer) comprises:

(a) a reflector block for receiving the optical signal from the beam-shaping lens;

(b) a plurality of filters for separating the different wavelengths from each other, one filter for a given wavelength; and

(c) a plurality of lenses, each lens associated with one filter, for directing the separated wavelengths onto individual receiving devices.

As with the above device, the combination of the beam-shaping device and the plurality of lenses, or lens array, is also of one-piece construction.

The combination of the optical fiber output beam-shaping device and WDM is of unitary, or one-piece, construction, thereby reducing alignment issues of introducing optical output from an optical fiber into (1) a beam-shaping lens and then (2) a WDM device. The cavity secures the optical fiber, the output end of which terminates at the fiber stop, which is planar and is perpendicular to the end of the optical fiber. The optical signal is then sent to the beam-shaping lens (the reflecting surface introduces the optical signal into the beam-shaping lens). Following shaping of the optical signal, the optical signal is split into its component wavelengths (at least two) by the WDM. Of course, the combination can be operated in reverse, and the optical signals combined in the WDM and the resulting shaped beam converged onto the end of the optical fiber for transmission.

Other objects, features, and advantages of the present invention will become apparent upon consideration of the following detailed description and accompanying drawings, in which like reference designations represent like features throughout the FIGURES.

### BRIEF DESCRIPTION OF THE DRAWINGS

The drawings referred to in this description should be understood as not being drawn to scale except if specifically noted.

FIG. 1 is a fragmentary, enlarged elevation view in section illustrating an optical fiber and a connector of the prior art, with the optical fiber shown exploded from the connector;

FIG. 2 is a fragmentary, enlarged elevation view in section illustrating an assembly of the optical fiber and connector shown in FIG. 1;

FIG. 3 is a schematic drawing, depicting the optical fiber output beam-shaping device of the present invention;

FIG. 4 is a schematic drawing of the optical fiber output beam-shaping device of FIG. 3, depicting a ray trace (Code V) illustrating the separation of multiple signals from a single optical signal;

FIG. 5 is a fragmentary, enlarged elevation view in section illustrating the combination of the optical fiber beam-shaping device and a wavelength division multiplexer including a lens array; and

6a-6b are cross-sectional views depict molding of the one-piece combination of the optical fiber output beam-shaping device of the present invention and the lens array, with

FIG. 6a depicting the combination during molding and with

FIG. 6b depicting the mold separated for extracting the combination.

### Best Modes for Carrying Out the Invention

Reference is now made in detail to a specific embodiment of the present invention, which illustrates the best mode presently contemplated by the inventor for practicing the invention. Alternative embodiments are also briefly described as applicable.

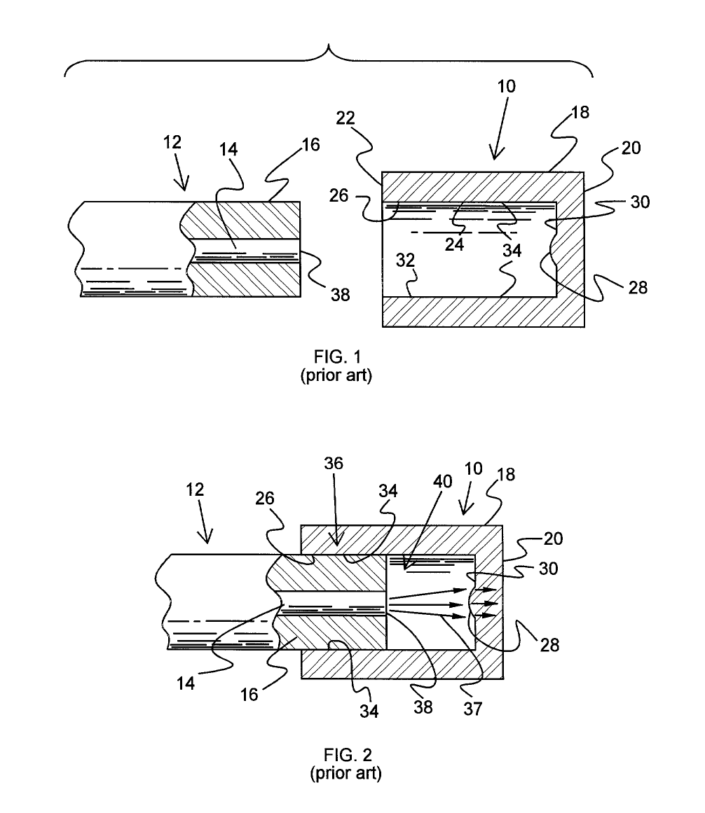

FIGS. 1 and 2 depict a prior art connector 10 for an optical fiber 12 having a light transmissive, or fiber, portion 14 surrounded by a layer 16 of insulative material that covers and protects the fiber portion. The connector 10 comprises a single piece body 18 molded from a light transmissive plastic material. The body 18 has a light transmissive front end 20 and an opposite rear end 22. A cavity 24 has an entrance 26 communicating with the rear end 22 for receiving the optical fiber 12. The cavity 24 extends toward the front end 20. A spherical collimating lens 28 faces the interior of the cavity 24 and is formed on an end wall 30 of the cavity opposite the entrance 26. The interior surface 32 of the cavity 24 forms a holder 34 for frictionally gripping the optical fiber 12, with the cross-section of the cavity matching that of the optical fiber.

FIG. 2 shows a connector assembly 36 wherein the optical fiber 12 is received through the entrance 26 and is retained by the holder 34 in the cavity 24 opposite the lens 28. An optical signal 37 emerges from an end 38 of the fiber 14 and diverges while being transmitted through an air gap 40 separating the end of the optical fiber 12 and the lens 28. The lens 28 collimates the optical signal 37, which is transmitted through the body 18 and through the end 20 of the body.

Alignment of the holder 34 and the lens 28 is achieved by molding the connector 10 from “fluent” plastic in a molding apparatus (not shown). The cavity 24 is formed by a single core pin (not shown), with the surface of the core pin machined accurately to form both the lens 28 and the holder 34 during fabrication of the body 18.

While this reference provides alignment of an optical fiber 12 and a collimating lens 28, it fails to disclose or suggest launching optical radiation from the optical fiber into a WDM; consequently, it fails to disclose or suggest how alignment between an optical fiber and a WDM may be maximized.

Several schemes exist to separate (or combine) multiple wavelengths from (or into) an optical fiber. Typically, the optical output of the fiber is directed to a collimating lens, or other beam-shaping lens, and then from the collimating lens into a series of bandpass filters. The need for an optical fiber stop to set the distance from the optical fiber to the collimating lens may require a two-piece assembly. This may be due to molding (manufacturing) issues. On the other hand, as seen from U.S. Pat. No. 4,718,744, one-piece assemblies are known, although no optical fiber stop is shown or suggested therein.

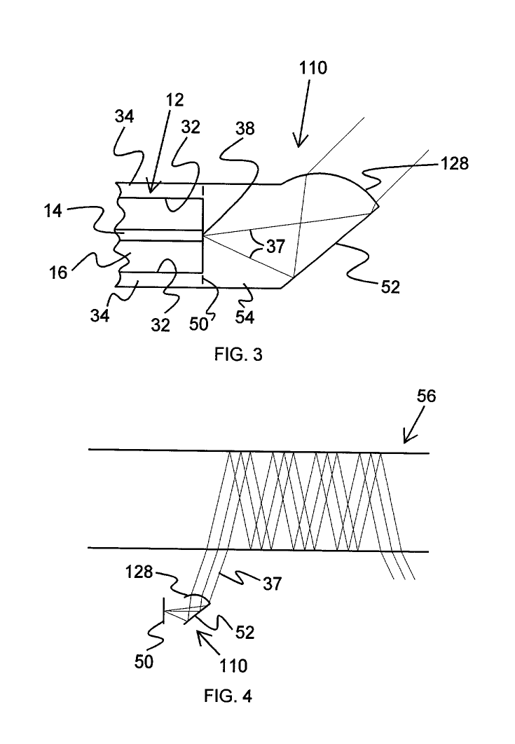

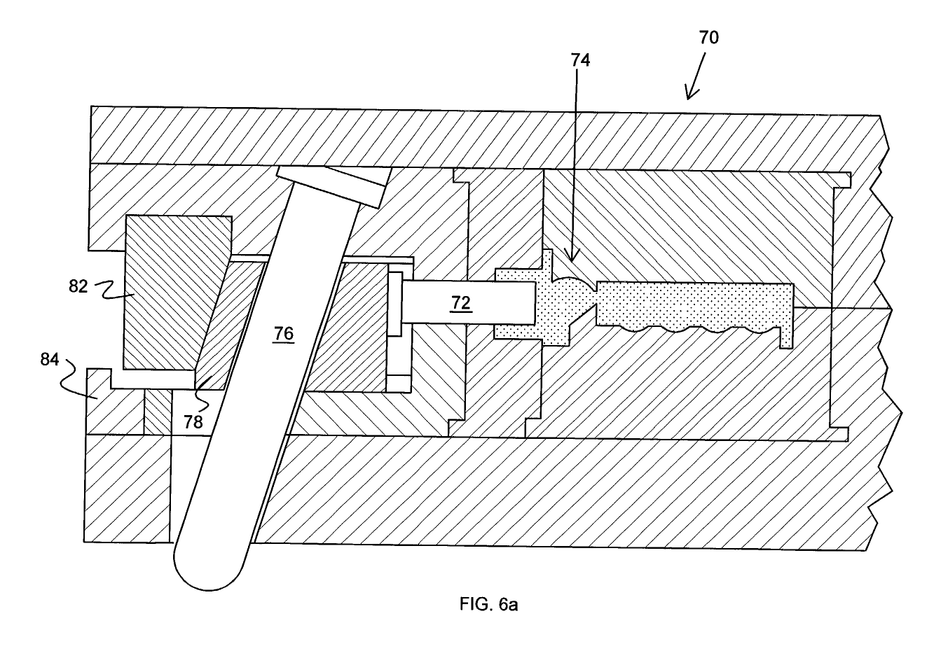

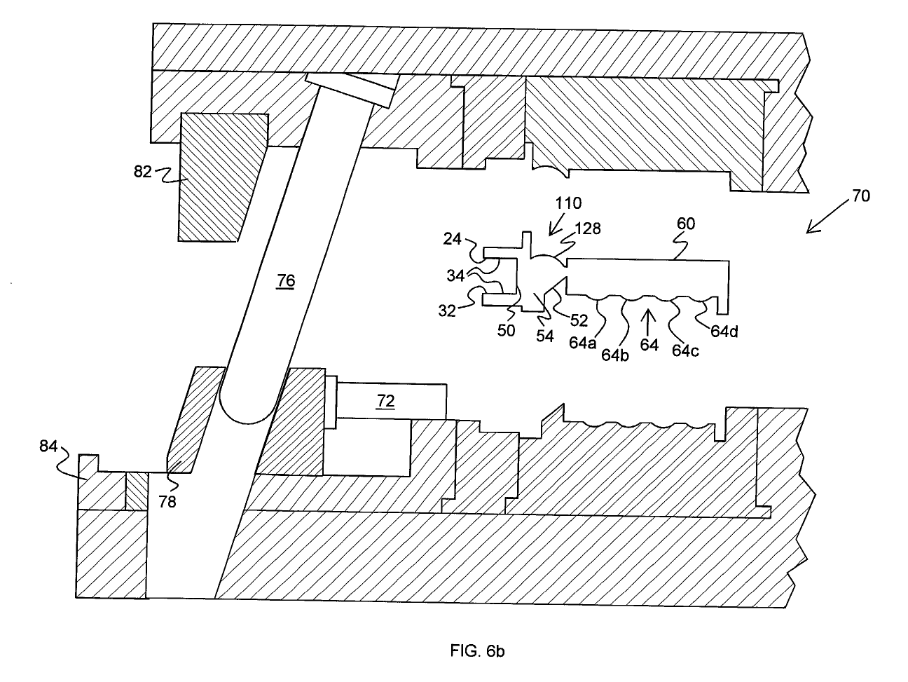

In accordance with the present invention, an optical fiber beam-shaping output device, or connector, 110 is provided, as shown schematically in FIG. 3. The connector 110 is molded in a one-piece assembly, which, in addition, simplifies manufacturing and reduces alignment issues. Discussion of the one-piece molding process is discussed below with reference to FIGS. 6a-6b.

The connector 110 comprises (1) a fiber stop 50, against which the end 38 of the optical fiber 12 is terminated, (2) a reflecting surface 52, which provides reflection of the optical signal 37 emanating from the end of the optical fiber, and (3) a beam-shaping lens 128 for shaping the optical signal. The connector 110 further includes the holder 34 with its interior surface 32 and cavity 24, into which the optical fiber 12 is inserted and secured, as described above.

The reflecting surface 52 may comprises a mirror or total internal reflection (TIR) surface. If a mirror is employed as the reflecting surface 52, then, for example, a silvered surface may be used. Alternatively, and more preferred, a TIR surface 52 is used. In the latter case, the required angle of incidence for TIR (known as the critical angle) at surface 52 is determined by the ratio of the refractive indices of the two materials on either side of surface 52, which in this example is plastic and air. This is well understood by those knowledgeable in the field of optics. The orientation of the TIR surface 52 (and its shape if not plano) is thus constrained by the ratio of the refractive indices, and the range or angular orientation of the optical signal 37 emanating from the optical fiber 12.

The mirror or TIR surface 52 may be, and preferably is, plano. Alternatively, the mirror or TIR surface 52 may be of some spheric or aspheric shape, to be used in combination with the beam-shaping lens 128. If a mirror 52 is used and it is piano, then the mirror is called a fold mirror.

The beam-shaping lens 128 is formed to a desired shape in the molding process, and may be either a refractive lens, a diffractive lens, or a hybrid refractive/diffractive lens. Preferably, the beam-shaping lens 128 is an asphere or other suitable shape, in order to shape, i.e., collimate, the optical beam 37. Alternatively, the beam-shaping lens 128 need not provide “true” collimation, but may render the optical signal 37 slightly converging (or diverging).

In the connector 110, the fiber stop 50, the reflecting surface 52, and the beam-shaping lens 128 are part of a solid block 54 forming the connector. The optical radiation 37 is bent by reflection from the reflecting surface 52 and then is shaped by the beam-shaping lens 128. The optical radiation can then be put through a multiple filter/reflector block 56 or other means of separating the different signals. It will be readily apparent to one skilled in this art that the connector 110 can be used in reverse to combine optical signals.

The solid block 54 comprises any of the known optical plastics that are moldable. Examples include poly(methyl methacrylates), polyether imides, polycarbonates, and polystyrenes. A plastic that is especially preferred in the practice of the present invention comprises a polyether imide, available under the tradename Ultem® from General Electric Plastics (Pittsfield, Mass.). While there are a number of grades of Ultem® PEI resin, one that has found use in the practice of the present invention is Ultem® 1000.

A ray trace (Code V, available from Optical Research Associates, Pasadena, Calif.) is depicted in FIG. 4, showing the separation into the different optical signals by a reflector block 56 resulting from a collimated optical signal emanating from the connector 110.

The connector 110 of the present invention thus combines stop 50, mirror 52, and beam-shaping lens 128 to be fabricated in a single piece 54, which improves the moldability by reducing the precision of a required slide, discussed below in conjunction with FIGS. 6a-6b. Specifically, if the stop 50 is a plane normal to the fiber 12, its decenter is not as critical, as compared to having the lens first (ahead of the plane). Consequently, alignment issues are reduced.

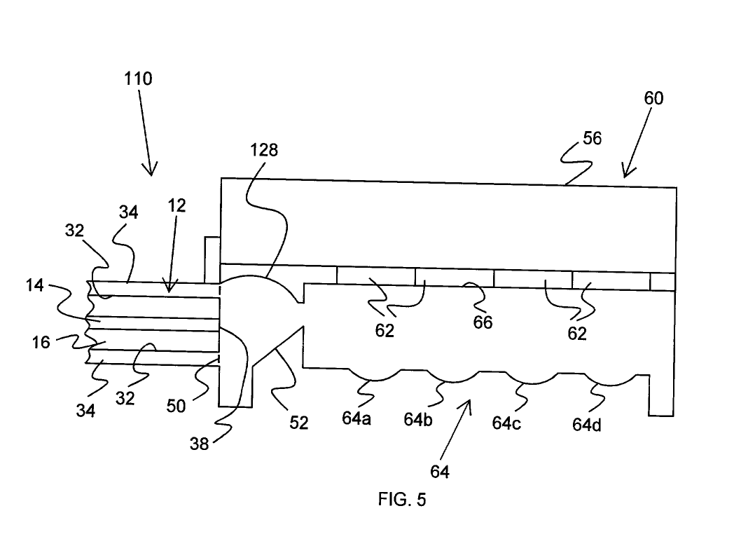

FIG. 5 depicts the connector 110 of the present invention in combination with a wavelength division multiplexer 60. The WDM 60 includes the reflector block 56 and a plurality of filters 62 to separate the wavelengths. A lens array 64 is shown (four such lenses 64a-64d in the array are depicted), for focusing the optical radiation at each different wavelength onto a detector (not shown) or optical fiber (not shown) or waveguide (not shown). While four such lenses 64a-64d are shown in the lens array 64, it will be appreciated that the number of lenses is pre-determined by the number of different wavelengths that emanate from the optical fiber 12. That is to say, the WDM 60 is configured to process a known number of different wavelengths to be carried on the optical fiber 12.

While the discussion above is directed to forming the optical fiber output beam-shaping device 110 as a unitary body, it is preferred to fabricate the combination of the device and the lens array 64 as a unitary body (the reflector block 56 and filters 62 are added subsequent to the molding process). In this manner, any alignment issues relating to aligning the end 38 of the optical fiber 12 with the WDM 60 are reduced, since the cavity 24 serves to hold the optical fiber securely against the fiber stop surface 50. Addition of the reflector block 56 and filters 62 to surface 66 of the lens array 64 to complete the WDM assembly 60 is easily within the purview of those skilled in this art.

FIGS. 6a and 6b depict the fabrication of the combination of the connector 110 and the lens array 64 as a unitary body in a mold apparatus 70. A core pin 72 is used to form the cavity 24 during molding. The molding operation is shown in FIG. 6a, with the plastic filling the mold 74. An angle pin 76 is engageable in slide 78, to which the core pin 72 is secured. The angle pin 76 permits disengagement of the core pin 72 from the cavity 24 upon completion of molding, thereby permitting molding of the connector 110 and the lens array 64 in a single piece. Following retraction of the core pin 72 from the cavity 24, the combination of the connector 110 and lens array 64 is removed from the mold 74, as shown in FIG. 6b. The reflecting block 56 and filters 62 are then secured to surface 66 of the lens array 64, using, for example, a suitable optical cement.

Lock 82 and stop 84 cooperate to limit the movement of the slide 78 during assembly and disassembly of the molding apparatus 70.

One skilled in this art of injection molding of lenses would appreciate that the various lens surfaces may be formed by individually inserted pins, not as a solid block as shown. To illustrate the basic aspects of molding the connector 110 and lens array 64 as a one-piece body, however, such individual pins are not shown in FIGS. 6a-6b. Further, it will be appreciated that the lens array portion 64 may be eliminated from the mold 74 to thereby fabricate only the connector 110 as a one-piece body.

### Industrial Applicability

The optical fiber output collimating device is expected to find use in coupling optical fibers to wavelength division multiplexers (or demultiplexers).

Thus, there has been disclosed an optical fiber output beam-shaping device for a wavelength division multiplexer. It will be readily apparent to those skilled in this art that various changes and modifications of an obvious nature may be made, and all such changes and modifications are considered to fall within the scope of the present invention, as defined by the appended claims.

What is claimed is:

1. An optical fiber output beam-shaping device for coupling an optical signal between an optical fiber and a wavelength division multiplexer or wavelength division demultiplexer, wherein said optical signal comprises at least two different wavelengths, said device comprising:
(1) a body of optically transmissive plastic;
(2) a cavity within said body having an entrance for receiving an end portion of said optical fiber and terminating at a fiber stop, against which an end of said optical fiber is terminated;
(3) a reflecting surface formed in said body opposite said end of said optical fiber, which provides reflection of said optical signal emanating from said end of said optical fiber, and (4) a beam-shaping lens formed in said body for shaping said optical signal reflected from said reflecting surface,
whereby said device is of one piece construction.

2. The device of claim 1 wherein said reflecting device comprises a mirror or total internal reflection surface.

3. The device of claim 2 wherein said mirror comprises a silvered surface on an exterior portion of said body.

4. The device of claim 2 wherein said total internal reflection surface comprises a surface on an exterior portion of said body formed at an angle.

5. The device of claim 1 wherein said beams-shaping lens is refractive, diffractive, or hybrid refractive/diffractive.

6. The device of claim 5 wherein said lens collimates said optical signal.

7. The device of claim 5 wherein said lens converges or diverges said optical signal.

8. The device of claim 1 wherein said body comprises an optical, moldable plastic.

9. The device of claim 8 wherein said plastic is selected from the group consisting of poly(methyl methacrylates), polyether imides, polycarbonates, and polystyrenes.

10. The device of claim 9 wherein said plastic consists essentially of a polyether imide.

11. In combination,
(a) an optical fiber output beam-shaping device for coupling an optical signal between an optical fiber and a wavelength division multiplexer or wavelength division demultiplexer, wherein said optical signal comprises at least two different wavelengths, said device comprising:
(a1) a body of optically transmissive plastic,
(a2) a cavity within said body having an entrance for receiving an end portion of said optical fiber and terminating at a fiber stop, against which an end of said optical fiber is terminated,
(a3) a reflecting surface formed in said body opposite said end of said optical fiber, which provides reflection of said optical signal emanating from said end of said optical fiber, and
(a4) a beam-shaping lens formed in said body for shaping said optical signal reflected from said reflecting surface; and
(b) said wavelength division multiplexer or wavelength division demultiplexer comprising:
(b1) a reflector block for receiving said optical signal from said beam-shaping lens;
(b2) a plurality of filters for separating said different wavelengths from each other, one filter for a given wavelength; and
(b3) a plurality of lenses, each lens associated with one said filter, for directing said separated wavelengths onto individual receiving devices, wherein said optical fiber output beam-shaping device and said plurality of lenses are of one-piece construction.

12. The combination of claim 11 wherein said reflecting device comprises a mirror or total internal reflection surface.

13. The combination of claim 12 wherein said mirror comprises a silvered surface on an exterior portion of said body.

14. The combination of claim 12 wherein said total internal reflection surface comprises a surface on an exterior portion of said body formed at an angle.

15. The combination of claim 11 wherein said collimating lens is refractive, diffractive, or hybrid refractive/diffractive.

16. The combination of claim 15 wherein said lens collimates said optical signal.

17. The combination of claim 15 wherein said lens converges or diverges said optical signal.

18. The combination of claim 11 wherein said body comprises an optical, moldable plastic.

19. The combination of claim 18 wherein said plastic is selected from the group consisting of poly(methyl methacrylates), polyether imides, polycarbonates, and polystyrenes.

20. The combination of claim 19 wherein said plastic consists essentially of a polyether imide.

21. In combination, an optical fiber output beam-shaping device for coupling an optical signal between an optical fiber and a lens array, wherein said optical signal comprises at least two different wavelengths, said device comprising:
(1) a body of optically transmissive plastic,
(2) a cavity within said body having an entrance for receiving an end portion of said optical fiber and terminating at a fiber stop, against which an end of said optical fiber is terminated,
(3) a reflecting surface formed in said body opposite said end of said optical fiber, which provides reflection of said optical signal emanating from said end of said optical fiber, and
(4) a beam-shaping lens formed in said body for shaping said optical signal reflected from said reflecting surface; and said lens array comprising a plurality of lenses, each configured to receive a selected wavelength from a plurality of wavelengths,
wherein said optical fiber output beam-shaping device and said plurality of lenses are of one-piece construction.

22. The combination of claim 21 wherein said reflecting device comprises a mirror or total internal reflection surface.

23. The combination of claim 22 wherein said mirror comprises a silvered surface on an exterior portion of said body.

24. The combination of claim 22 wherein said total internal reflection surface comprises a surface on an exterior portion of said body formed at an angle.

25. The combination of claim 21 wherein said collimating lens is refractive, diffractive, or hybrid refractive/diffractive.

26. The combination of claim 25 wherein said lens collimates said optical signal.

27. The combination of claim 27 wherein said lens converges or diverges said optical signal.

28. The combination of claim 21 wherein said body comprises an optical, moldable plastic.

29. The combination of claim 28 wherein said plastic is selected from the group consisting of poly(methyl methacrylates), polyether imides, polycarbonates, and polystyrenes.

30. The combination of claim 29 wherein said plastic consists essentially of a polyether imide.
